(19) United States
(12) Patent Application Publication
(10) Pub. No.: US 2024/0119862 A1
(43) Pub. Date: Apr. 11, 2024

(54) SYLLABLE-BASED TEXT CONVERSION FOR PRONUNCIATION HELP

(71) Applicant: INTERNATIONAL BUSINESS MACHINES CORPORATION, ARMONK, NY (US)

(72) Inventors: Wei Jun Zheng, Shanghai (CN); Xiao Xia Mao, Shanghai (CN); QING LU, Shanghai (CN); Yuan Jin, Shanghai (CN); Xiao Feng Ji, Shanghai (CN)

(21) Appl. No.: 17/936,101

(22) Filed: Sep. 28, 2022

(51) Int. Cl. G09B 19/06; G09B 5/06; G10L 13/08; G10L 25/18

(52) U.S. Cl. CPC G09B 19/06; G09B 5/06; G10L 13/08; G10L 25/18

(57) ABSTRACT

A method, computer system, and a computer program product for syllable-based pronunciation help are provided. An input text in a first language may be received. A selection of a target language that is different from the first language may be received. From the target language, syllables with a pronunciation most closely matching a pronunciation of the input text in the first language are obtained. The obtaining is based on a comparison of one or more spectrograms for the input text with one or more spectrograms for text of the target language. The obtained syllables in the target language are presented.

### BACKGROUND

The present invention relates generally to the field of natural language processing and machine learning, and more particularly to implementing these concepts for helping, in an automated manner, to provide pronunciation help for speakers of multiple languages.

Some text such as a word, a phrase, and/or a sentence may be unfamiliar to a reader who is reading the text, e.g., in a document. It may not be apparent for the reader how to pronounce some or all of the text. This challenge is especially heightened for those who are not expert speakers in a language, for example, for those who are learning a second language or who are non-native speakers of a language. A worker might be uncertain how to pronounce the name of a colleague when the worker meets that colleague in an online meeting. A reader may be participating in a technical discussion and come across a technical term which the reader has never before seen or heard. Travelers may especially experience these pronunciation challenges. Proper names often create these types of pronunciation challenges because of the large possible variety of pronunciations for proper names. Some languages include sounds which are not used in other languages, which intensifies these pronunciation challenges. There are often small or large differences in the pronunciation habits between various languages.

Among the existing solutions, international phonetic alphabets and phonics are sometimes helpful to provide a standard pronunciation of a new word. Some people are, however, unfamiliar with international phonetic alphabets and phonics.

Text-to-audio technology also helps with pronunciation challenges in some instances. But sometimes a speaker inexperienced with a particular language might find a text-to-audio computer pronunciation of text to be strange and not easy to follow the first time. The speaker might not catch subtleties regarding the correct pronunciation. Sometimes, the setting is not appropriate for a reader to hear a computer audio pronunciation of text. In some instances it would be helpful for the reader to see the proper pronunciation using syllables from their primary language and/or from a language with which they have more experience. Many people have the most confidence with a primary language, e.g., with their native language, and prefer tips to be provided in their primary language even more than using phonics or the international phonetic alphabet.

KR 10-1990021 Ba relates to a device and a method for displaying a foreign language and a mother tongue by using English phonetic symbols. The device includes a conversion server which separates the separated foreign language words into phonemes by using predetermined phonetic symbols and generates a part corresponding to a syllable of a foreign language word of the separated foreign language phonemes into a mother tongue phoneme of mother tongue consonants and vowels in accordance with a predetermined foreign language pronunciation rule.

“Incorporating Pronunciation Variation into Different Strategies of Term Transliteration” by Kuo et al. discloses that term transliteration addresses the problem of converting terms in one language into their phonetic equivalents in the other language via spoken form. Kuo et al. proposed several models, which take pronunciation variation into consideration, for term transliteration. The models describe transliteration from various viewpoints and utilize the relationships trained from extracted transliterated-term pairs.

The prior art has the disadvantage of requiring system trainers to have specific bilingual proficiency to extract transliterated-term pairs and/or to establish predetermine foreign language pronunciation rules.

### SUMMARY

According to one exemplary embodiment, a method for syllable-based pronunciation help are provided. An input text in a first language may be received. A selection of a target language that is different from the first language may be received. From the target language, syllables with a pronunciation most closely matching a pronunciation of the input text in the first language are obtained. The obtaining is based on a comparison of one or more spectrograms for the input text with one or more spectrograms for text of the target language. The obtained syllables in the target language are presented. A computer system and computer program product corresponding to the above method are also disclosed herein.

With these embodiments, automated pronunciation help may be achieved which provides the help using a preferred language of the person who is requesting the help. An automated pronunciation help system generates pronunciation tips between multiple languages. Different languages may be evaluated and interpreted even on the fly to provide translation and pronunciation help. This help may be provided without needing to rely on finding individuals with bilingual proficiency for many different language pair combinations. This help may be provided without needing to generate huge numbers of inter-language pronunciation pairs through brute force listening, evaluation, and recording of those inter-language pronunciation pairs. Automated pronunciation help is provided with pronunciation tips on a syllable-based level.

In some additional embodiments, the input text may be separated into syllables in the first language. The syllables in the first language are used to generate the one or more spectrograms for the input text. A time to pronounce each of the syllables in the first language may be calculated. Points of zero amplitude in an audio waveform generated via pronouncing the input text may be identified. An input text spectrogram for the input text may be divided into a spectrogram per syllable of the input text. The dividing may be based on the calculated time and/or on the identified points of zero amplitude.

In this way, pronunciation help may be achieved in a more precise automated manner by allowing comparison on a syllable-based level of various texts and spectrogram-producing pronunciations. Pronunciation help may be achieved in an automated manner without a person who is involved in the training needing expert knowledge in any of the languages for which the program will be trained.

In some additional embodiments, an audio waveform of the pronunciation of the input text in the first language may be recorded. The one or more spectrograms for the input text may be generated based on the audio waveform.

In this way, input information may be produced and pre-processed for better usage in a machine learning model which may be a part of or used by the program for syllable-based pronunciation help. By preparing the data for use with a machine learning model, the breadth of possible pronunciation tips may be exponentially expanded as compared to tips that could be generated based on brute manual recognition of similar-sounding syllables between languages.

In some additional embodiments, embeddings from the spectrograms may be generated for the comparisons. Cosine similarity calculations may be performed to compare the similarity of sounds (via their spectrograms) between languages.

In this way, machine learning models may be utilized to enhance language comparison so that the breadth of possible pronunciation tips may be vastly expanded across multiple languages, e.g., up to two hundred languages or more.

In some additional embodiments, presenting of the obtained syllables in the target language may include displaying the obtained syllables in the target language on a screen of the computer along with other text in the first language and/or playing an audio recording of the syllables in the target language.

In this manner, the computer operating this program may become an enhanced teleprompter to help a user who is giving a presentation. The pronunciation help may be given in a multi-sensory manner or in a sensory manner that is varied depending on the preferences or needs of the user.

In some additional embodiments, an indication of the first language may be received via a selection of the first language and/or via machine learning analysis of text being displayed on the computer. The input text may be received via a selection of a portion of text that is displayed on a screen of the computer. The selection of the portion of the text may be made via click-and-drag of a text box over the input text on the screen.

In this manner, the program facilitates nimble implementation so that a user and the program may quickly provide and receive input and allow the automated abilities of the program to perform syllable-based translation for pronunciation help. This nimble implementation is helpful for a user who is requesting the syllable-based pronunciation help during a presentation when a quick computing determination and response will enhance the presentation.

In at least some additional embodiments, the obtaining may be performed via a first machine learning model that is trained via a second machine learning model. For the training the second machine learning model may analyze embeddings representing the one or more spectrograms for the input text and the one or more spectrograms for text of the target language. Additionally and/or alternatively, an autoencoder may be used to train the first machine learning model. The autoencoder converts the one or more spectrograms for the input text and the one or more spectrograms for text of the target language into respective tokens. Additionally and/or alternatively, for the training the second machine learning model may analyze a combination of tokens representing textual syllables from the input text and tokens representing the one or more spectrograms for the input text.

In this manner, the program implements high-powered machine learning models to sift through large amounts of textual and audio data to quickly determine an appropriate cross-language pronunciation suggestion for helping enhance the clarity of speech of a presenter.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment in which syllable-based text conversion for pronunciation help may be implemented according to at least one embodiment;

FIG. 2A illustrates a pronunciation help environment when a user actuates the syllable-based text conversion according to at least one embodiment;

FIG. 2B illustrates the pronunciation help environment shown in FIG. 2A but in a subsequent instance when and/or after the user has received the syllable-based text conversion for pronunciation help according to at least one embodiment;

FIG. 3 is an operational flowchart illustrating a process for preparation for training a syllable-based text conversion program according to at least one embodiment;

FIG. 4 illustrates the use of an audio waveform for syllable-based text conversion according to at least one embodiment;

FIG. 5 illustrates a pipeline for training a syllable-based text conversion program according to at least one embodiment;

FIG. 6A illustrates a pipeline for training an encoder according to at least one embodiment and to be used in the training pipeline shown in FIG. 5;

FIG. 6B illustrates a policy gradient for helping train a syllable-based text converter according to at least one embodiment;

FIG. 7 illustrates a pipeline for training a text-to-audio generator according to at least one embodiment and that may be used in the training pipeline shown in FIG. 5;

FIG. 8 illustrates a pipeline for training an audio encoder according to at least one embodiment and which may be used in the training of the text-to-audio generator that is depicted in FIG. 7; and

FIG. 9 illustrates a prediction phase pipeline according to at least one embodiment and for implementing the syllable-based text converter that was trained via the pipeline shown in FIG. 5 and for performing pronunciation help for text that is input by a user.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a system, a method, and a computer program product for providing automated pronunciation help, e.g., for a speaker who is reading a language with which the speaker is inexperienced. The present embodiments provide automated pronunciation help which is capable of generating pronunciation tips in a different language compared to the language being read by a user. The present embodiments provide an automated pronunciation help system which has the capacity to interpret and evaluate different languages on the fly in order to provide translation and pronunciation help. The present embodiments provide pronunciation help without needing to perform, by a person, brute force listening, evaluation, and recording of inter-language pronunciation pairs to find or generate huge numbers of inter-language pronunciation pairs. The present embodiments provide an automated pronunciation guide which provides pronunciation tips on a syllable-based level. The present embodiments implement principles of machine learning in order to enhance automated pronunciation help across different languages.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as syllable-based text conversion 116. In addition to syllable-based text conversion 116, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and syllable-based text conversion 116, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

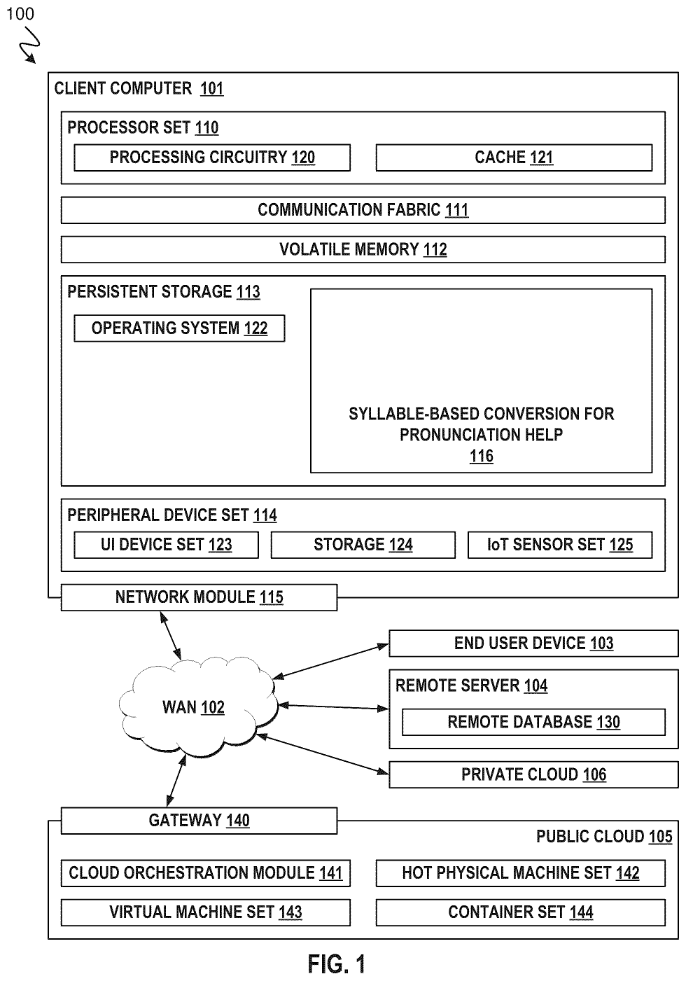

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in syllable-based text conversion 116 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in syllable-based text conversion 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

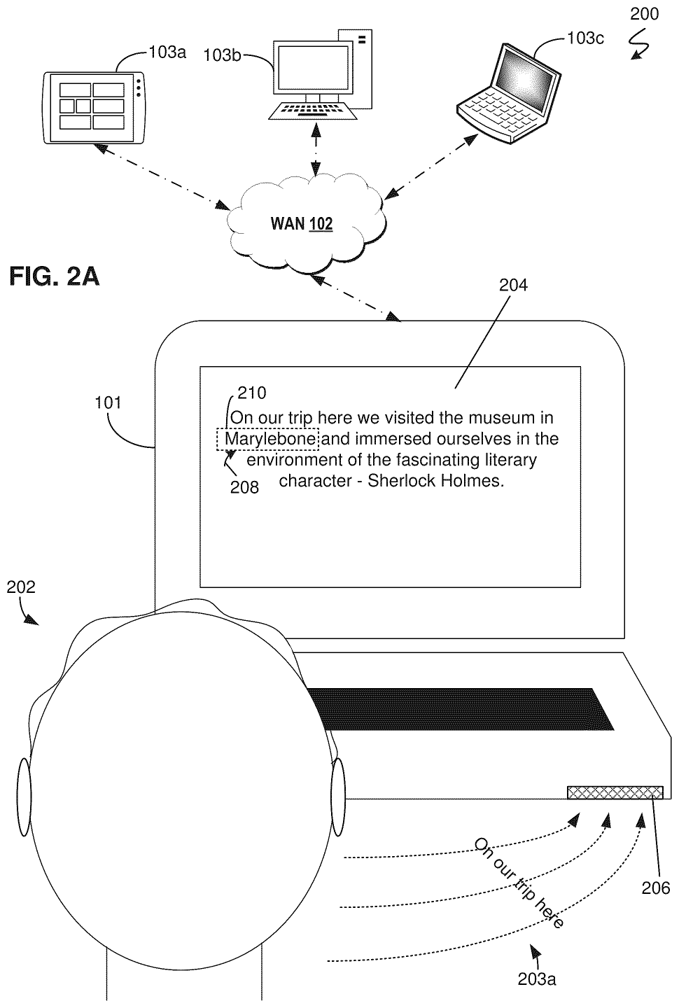

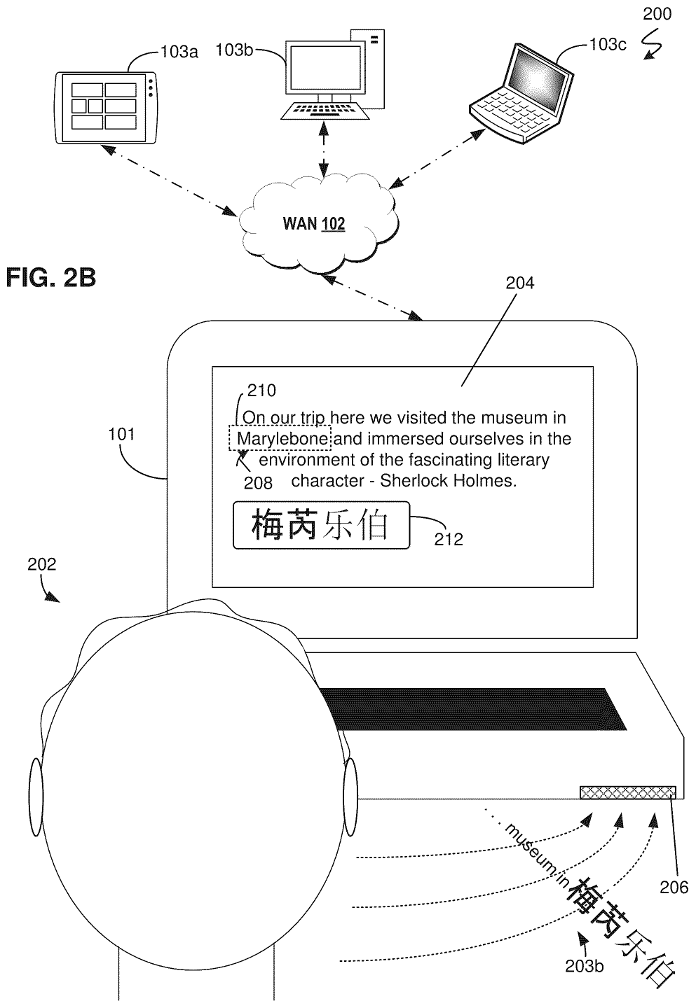

FIG. 2A illustrates a pronunciation help environment 200 in which a user 202 may implement the syllable-based text conversion 116, e.g., to obtain pronunciation help. The user 202 is shown in FIG. 2A as working on a laptop computer which is an example of the client computer 101 shown in FIG. 1. Because the user 202 is facing the display screen 204 of the laptop in order to see the words displayed on the display screen 204, FIGS. 2A and 2B show a view of the back of the head of the user 202. The user 202 is speaking to create first spoken words 203a that are being captured via a microphone 206 of the client computer 101. The microphone 206 is an example of the UI device set 123 shown in FIG. 1 and described above. The user 202 may speak to create an audio message that is recorded and created in the client computer 101. The audio message may be transmitted via the WAN 102 to other devices such as the first end user device 103a shown in the form of a smart phone, a second end user device 103b shown in the form of a desktop computer with a display screen, and a third end user device 103c shown in the form of a laptop computer. Each of these first, second, and third end user devices 103a, 103b, 103c are computers, include speakers to play audio messages, and are examples of the End User Device 103 shown in FIG. 1 and described above. In the pronunciation help environment 200 depicted in FIG. 2A, the user 202 is receiving assistance for his verbal presentation in that words for him to speak are being displayed on a display screen 204 of the client computer 101.

The user 202 may recognize, e.g., in advance, that one or more displayed words to be read may have a difficult pronunciation, e.g., due to the unusual nature of that displayed word and/or due to the inexperience of the user 202 in the particular language. For example, the user 202 may be from China and speak English as a second language. For many such speakers, unusual terms provide extra difficulty for the speaker to pronounce. This user 202 sees the word “Marylebone” and is uncertain how to pronounce this word. An incorrect or unclear pronunciation may reduce the clarity and/or understandability of the presentation that is being provided by the user 202 to one or more end users, e.g., to respective end users at the first, second, and third end user devices 103a, 103b, 103c.

The user 202 may seek for pronunciation help by invoking the syllable-based text conversion 116 that is a computer program stored on the client computer 101. The user 202 may actuate a mouse cursor 208 to generate a first text box 210 to provide an input text to the syllable-based text conversion 116. The user may actuate a first button of the mouse or other input device to signal a desired starting of a text box. The user may then move the mouse or other input device to enlarge the text box and shift the text box to cover one or more of the words that are being displayed on the display screen 204. This movement may occur as a click-and-drag performed via the user 202 actuating the mouse or other input device. In the present example, the user 202 has generated and moved the first text box 210 to encompass and/or surround the word “Marylebone” and no other word of the other text that is currently being displayed on the display screen 204. When the first text box 210 is in the desired position surrounding the text for which the user 202 seeks pronunciation help, the user 202 may actuate another input device or perform another actuation at the mouse in order to indicate a selection of the text.

The user 202 previously activated the program for syllable-based text conversion 116 on the client computer 101, e.g., via one or more actuations via the mouse, in order to enter and/or activate a stage in which mouse/input device actuation triggers generation of the text box, e.g., of the first text box 210, that may be placed around some displayed text of the display screen 204.

Besides providing the input of the selected input text, the user 202 also provides as input into the program for syllable-based text conversion 116 a target language for the text conversion. In the depicted embodiment, the user 202 selects Mandarin Chinese as the target language for the text conversion. Mandarin Chinese may be a native language of the user 202 and/or the user may speak and/or read Mandarin Chinese with native proficiency. The user 202 may use one or more input devices connected to the client computer 101 to input the target language. For example, the user 202 may actuate a mouse over a graphical user interface button of the program for syllable-based text conversion 116 to trigger selection of the target language. This actuation may trigger the generation of a target language text box into which the user 202 can type the name of the target language. Alternatively and/or additionally the actuation may trigger the display of a list of languages which the program for syllable-based text conversion 116 is capable of providing as output languages for the pronunciation help. The user 202 may use an input device such as the mouse to scroll through the list and to select one of the presented languages. The user may speak into a microphone that is connected to the client computer 101 in order to give verbal instructions for selecting the target language. The client computer 101 and/or the program may include speech-to-text transcription capabilities and other natural language processing capabilities to receive, understand, and carry out verbal instructions. The target language may also be selected by retrieving information from a user profile created by the user. Such a user profile may be created by the user and/or the program as the user registers for the program and/or downloads the program.

The program for syllable-based text conversion 116 may have various settings for selecting the target language. In one setting, the target language may be selected at the beginning of a session so that for every requested passage in the session a pronunciation help output is provided in the selected language. For example, in the depicted embodiment of FIGS. 2A and 2B the output language may be Mandarin Chinese for this entire session. For the embodiment depicted in FIGS. 2A and 2B, the user 202 selected Mandarin Chinese as the output language before the instances shown in FIGS. 2A and 2B, respectively. In another embodiment, the target language may be newly selected each time that a passage of the displayed text is selected for pronunciation help.

The program for syllable-based text conversion 116 also includes as input a source language. For the embodiments depicted in FIGS. 2A and 2B, the source language, e.g., the first language, is the English language. The source language may be automatically determined via the program for syllable-based text conversion 116 reading the text that is currently being displayed on the display screen 204. The program may implement one or more machine learning models to automatically recognize the source language based on the words that are displayed. Additionally and/or alternatively, the user 202 may use one or more input devices connected to the client computer 101 to input the source language. For example, the user 202 may actuate a mouse over a button of the program for syllable-based text conversion 116 to trigger a graphical user interface such as a pop-up window in order to prompt the user to select the source language from interacting with the graphical user interface. For example, this actuation may trigger the generation of a source language text box into which the user 202 can type the name of the source language. Alternatively and/or additionally the actuation may trigger the display of a list of languages for which the program for syllable-based text conversion 116 is capable of providing a conversion for the pronunciation help. The user 202 may use an input device to scroll through the list and to select one of the presented languages as the source language.

FIG. 2B illustrates the pronunciation help environment 200 that was shown in FIG. 2A but in a subsequent instance in time when the user 202 has received the syllable-based text conversion for pronunciation help according to at least one embodiment. Specifically, FIG. 2B shows that the program for syllable-based text conversion 116 has generated pronunciation help converted text 212 which shows syllable-based characters in the target language which indicate how to pronounce the input text from the selected text, e.g., from the first text box 210. In this example, the pronunciation help converted text 212 includes the Chinese characters [symbol] which show a Mandarin-Chinese approximation for pronouncing the English word Marylebone. The computer implementing this program for syllable-based text conversion 116 may be deemed an enhanced teleprompter via its display of a combination of (1) original source language text to be read by a user as well as (2) pronunciation help converted text 212 in a target language. This enhanced teleprompter not only helps a reader know which words to read but also provides pronunciation help for words in the text that are difficult to pronounce and/or read.

In some embodiments where the user 202 is performing screen sharing as part of an online live presentation when the pronunciation help was requested, the pronunciation help converted text 212 may be redacted and/or removed from the screen view before screen content is transmitted to other computers. The screen content without the redacted/blocked portion may be transmitted from the client computer 101 of the user 202 and over the WAN 102 to be displayed on screens of the various users listening to the presentation and watching the screen sharing, e.g., on the first, second, and third end user devices 103a, 103b, 103c.

FIG. 2B also shows that the user 202 has availed himself/herself of the pronunciation help that was provided by the program for syllable-based text conversion 116 and specifically was provided by the generation of the pronunciation help converted text 212. FIG. 2B shows that the user 202 has seen the pronunciation help converted text 212 and then spoken, as second spoken words 203b, the statement that included the audible version of the converted phrase. Thus, other users who are presently listening to an audio presentation being provided by the user 202 or who will subsequently listen to a recording of the presentation may hear the presentation more clearly and understand which entity was spoken by the user.

In addition to the pronunciation help converted text 212 being presented visibly with letters and/or characters, the program for syllable-based text conversion 116 may also generate the pronunciation help as audio sounds. For example, if the user 202 were wearing earphones the program for syllable-based text conversion 116 may also generate an audio presentation of the phrase “Marylebone” to assist the user 202 so that the user 202 can make a correct and/or improved pronunciation of a difficult phrase/term in his or her own voice. Such an audio presentation may be generated using a voice recording from a speaker speaking the target language or the source language. In some embodiments, the program for syllable-based text conversion 116 may allow the user 202 to select whether an audio pronunciation would be played by a source language speaker or by a target language speaker.

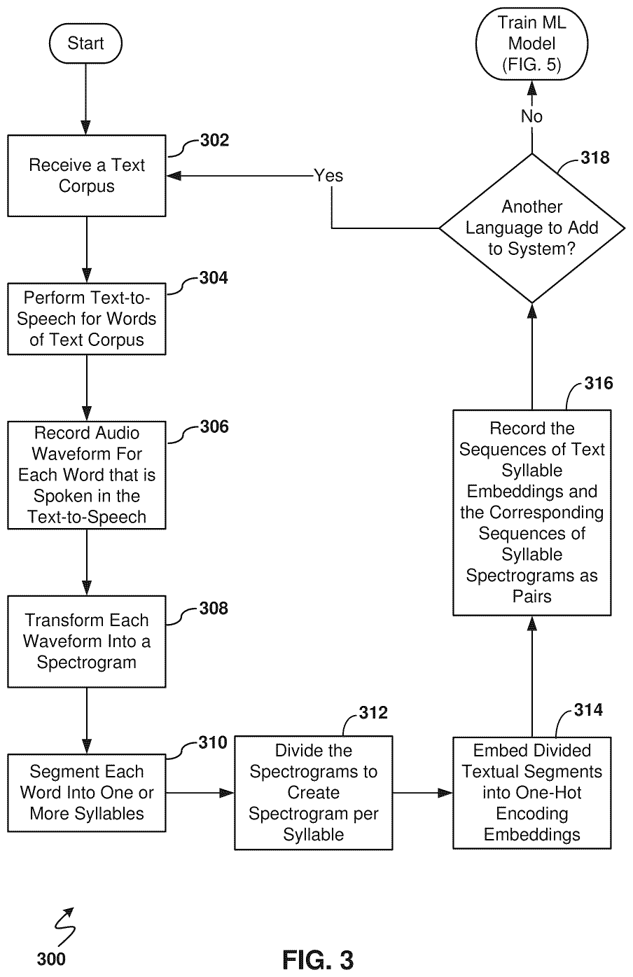

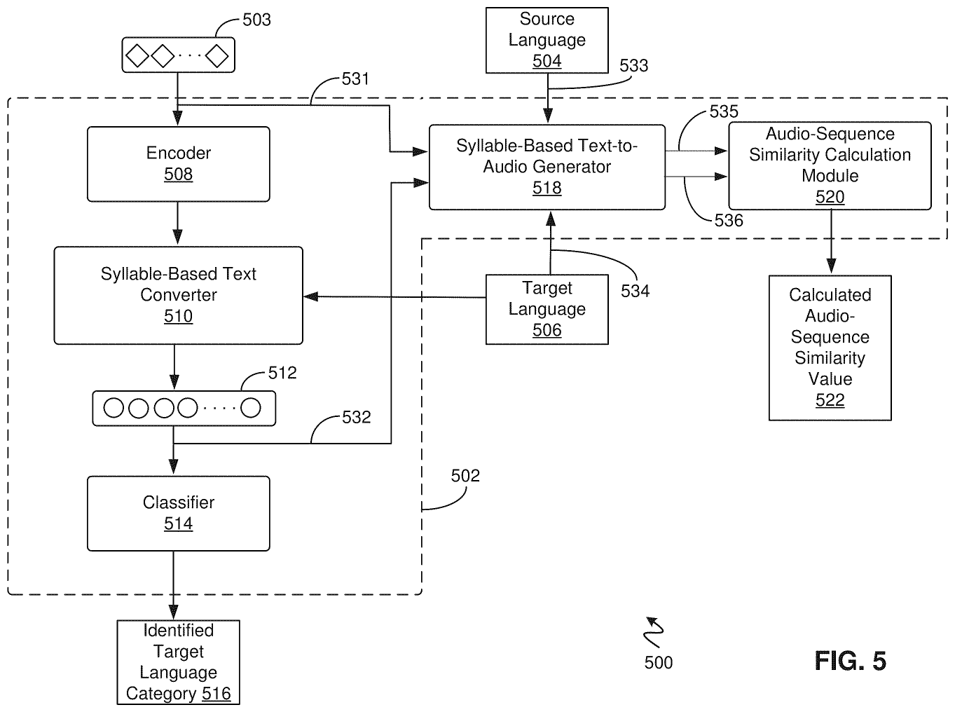

FIG. 3 illustrates an operational flowchart illustrating a converter training preparation process 300 for preparing to train a syllable-based text converter according to at least one embodiment. The syllable-based text converter may be part of the program for syllable-based text conversion 116 and may include one or more machine learning models. The program for syllable-based text conversion is used to provide pronunciation help as, for example, was depicted in and described above with respect to FIGS. 2A and 2B. FIG. 5 depicts a training pipeline for training the syllable-based text converter. Once the syllable-based text converter is trained, the syllable-based text conversion may be performed as depicted in FIGS. 2A and 2B by providing an input text and a target language to the program for syllable-based text conversion 116. The source language is input as well and may be selected by a user and/or automatically recognized via the program for syllable-based text conversion 116.

In step 302 of the converter training preparation process 300 shown in FIG. 3, a text corpus is received. A user may upload the text corpus as a file into a web portal of/for the program for syllable-based text conversion 116. The program may receive access to the text corpus in any equivalent fashion. A user may load such a file into a web portal via a computer. The receiving may occur via the program for syllable-based text conversion 116 receiving an uploaded file at a computer and/or server. Such file may be transmitted via a network such as the WAN 102 shown in FIG. 1. In some instances, the text corpus may be gleaned from books and encyclopedias such as an online encyclopedia. Thus, in some embodiments the step 302 may include web crawling to gather text in a particular language.

In step 304 of the converter training preparation process 300 shown in FIG. 3, text-to-speech is performed for words of the text corpus. This text corpus may be that text corpus that was received in step 302. For every sentence in the text corpus, the words may be pronounced one after another. The words are spoken by a person who preferably has native-speaking proficiency for the respective language. The words may also be spoken via an automated program. For example, step 304 may include repeatedly inputting a particular word into an online dictionary and actuating a GUI (graphical user interface) button to play a recording of the particular word.

As a part of step 304 or later as a part of step 310, pre-processing of the text training corpus data may be performed. This pre-processing may include converting any non-word characters in the text into a corresponding textual form. For example, numbers, percentage data, ‘.com’ etc. may be converted in this pre-processing. The following three sentences contain examples of this preprocessing. The number “8” may be pre-processed to read “eight”. The text “37%” may be pre-processed to be thirty-seven percent. The text “website.com” may be preprocessed to be “web site dot com”.

In some embodiments, some special words may not follow traditional pronunciation rules so that the text-to-speech program might not have a proper pronunciation stored for a word and may predict an incorrect pronunciation. As a supplement to the text-to-speech feature, step 304 may include accessing a special word mapping table which includes correctly-segmented syllables and the correct audio pronunciation for some special words. The mapping table may be a data structure that includes multiple data storage columns such as a first column for storing a (source) language of the special word, a second column for storing the special word itself, a third column for storing syllables of the word which were segmented by a native speaker or language expert, and a fourth column for storing an audio pronunciation clip of the special word spoken by a native speaker or a language expert.

The mapping table may in some embodiments include one or more additional columns which track common context words associated with the special word. Such context word tracking may be useful in instances when a single spelling of a word may have multiple pronunciations. For example, a first word or a first pair of words may have a first pronunciation when referring to a geographical location but have a second pronunciation when referring to a famous person. Some names may have a first pronunciation when referring to a first famous person and a second pronunciation when referring to a different second famous person. Other nouns and/or verbs in the vicinity of a text corpus with the particular special word may be identified and/or retrieved via the text/web crawling program and stored in the one or more context tracking columns. The program may query the mapping table in the first instance to check for the presence of a special word before turning to the text-to-speech module or to a word segmentation module.

Additionally, after initial training of the syllable-based text converter program for pronunciation help has been performed so that the program is ready, the program may regularly crawl the internet in multiple languages to look and/or listen for words such as proper nouns which are not part of the large text corpus from step 302. The crawling may especially be performed for certain languages such as English which include many words which defy usual pronunciation and syllable segmentation rules. When new words are identified in the crawling, a new entry may be generated in the above-described mapping table and a notification may be generated and sent to a language technician requesting that the technician provide an audio recording of pronunciation of the new special word and perform syllable textual segmentation of the special word or phrase.

In step 306 of the converter training preparation process 300 shown in FIG. 3, an audio waveform for each word that is spoken in the text-to-speech is recorded. This recording may include the use of a microphone that is connected in a wired or wireless manner to a computer involved in and performing the steps of the converter training preparation process 300. The audio waveform is a graph that displays a sound-related variable such as amplitude or level changes over time. The amplitude may be measured in a bipolar manner, with positive and negative values. Level changes may be an absolute value of amplitude changes or an average. The waveform may be a digitized recreation of dynamic voltage changes over time reflecting the sound that is produced. The audio waveforms may be stored at the computer memory of a computer involved in the training or in a server connected via the WAN 102 to one or more computers involved in the training.

In step 308 of the converter training preparation process 300 shown in FIG. 3, each audio waveform is transformed into a spectrogram. The audio waveforms are those that were recorded in step 306. This transformation may be performed via one or more computer programs which are part of a program for performing the converter training preparation process 300. Alternatively, the audio waveforms may be sent via the WAN 102 to another server which hosts an audio application configured to convert the audio waveform into a spectrogram. Such instances may implement a Fourier transformation in order to perform this transformation. A spectrogram is a visual representation of the spectrum of frequencies of a signal as the signal varies with time. A spectrogram is usually depicted as a heat map that is an image with the intensity shown by varying the color and/or brightness in the image. The spectrogram may be encoded into a computer accessible data structure.

In step 310 of the converter training preparation process 300 shown in FIG. 3, each word is segmented, e.g., separated, into one or more syllables. These words are the words of the text corpus that was received in step 302 and which were spoken in step 304 to produce the audio waveforms in step 306. A program for performing the converter training preparation process 300 may perform this segmentation and may include language-specific syllable-based text segmentation processing modules which perform the segmentation. The segmentation may be based on syllable division rules of the language for each sentence of the text corpus. Such syllable division rules may be programmed into each of the language-specific segmentation processing modules. This segmenting may implement aspects of natural language processing.

The segmentation of step 310 may also include the program analyzing the audio waveforms for each word that were recorded in step 306. This aspect may include calculating an approximate time that is required to pronounce each textual syllable. The program for performing this converter training preparation process 300 may include a single-syllable pronouncing time calculator that is a module. This calculation may be based on the known length of time for each of the vowel and consonant sounds that are within a particular syllable. For example if the word “avenger” were being analyzed and segmented in step 310, the single-syllable pronouncing time calculator may determine that the first syllable “a” takes 0.13 seconds to pronounce, that the second syllable “ven” takes 0.17 seconds to pronounce, and that the third syllable “ger” takes 0.3 seconds to pronounce. With this time calculation, the program may implement some aspects of natural language processing.

This calculation may include performing a search on the audio waveform, starting from a first textual syllable, and looking within a search range of k seconds before and after a most likely segmentation point on the time axis of the audio waveform of the current word being analyzed. The most likely segmentation point is determined by a calculated pronouncing time of the current and previous textual syllables. Within the range, the first time point where the wave line, e.g., the amplitude line, is zero is considered as the final segmentation point of the current textual syllable. This first time point may be recorded as a part of step 310.

For any language in which each word consists of one syllable, then step 310 may be omitted. For these languages, each word will inherently provide a syllable.

In step 312 of the converter training preparation process 300 shown in FIG. 3, the spectrograms are divided to create a spectrogram per syllable. These spectrograms are those that were created in step 308. The spectrogram is retrieved that was created for a particular word that is being segmented in step 310. This spectrogram is segmented at the same first time point that was identified in step 310 as being the final segmentation point for a particular syllable. Thus, for a word with more than one syllable its corresponding word-based spectrogram may be separated in step 312 into a multiple, smaller, syllable-based spectrograms.

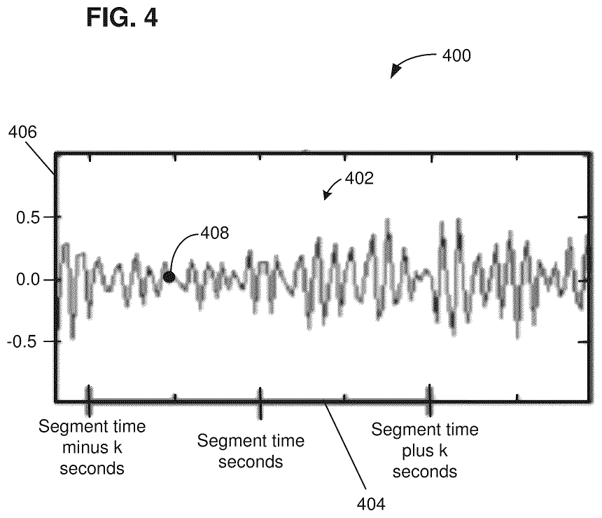

FIG. 4 illustrates aspects of steps 306 and 310 of the converter training preparation process 300. FIG. 4 shows a graph 400 which includes an audio waveform 402 which was recorded from a spoken word. The graph 400 includes an x-axis 404 and a y-axis 406. In the depicted embodiment, the x-axis 404 represents time. The y-axis 406 represents an amplitude of the recorded sound. In the graph 400, zero intersection point 408 represents a first time point within a search range where the wave line, e.g., the amplitude line, was/crossed zero. The search range is taken from a syllable pronunciation time that was determined as a part of step 310. For example, for the syllable “a” of the word avenger, the syllable pronunciation time is 0.13 seconds. Thus, 0.13 seconds would be the value for the “segment time” for the values along the x-axis 404 in the graph 400. The search range for this syllable in the audio waveform 402 is that segment between the “Segment time minus k seconds” mark on the x-axis 404 and the “Segment time plus k seconds” mark on the x-axis 404. FIG. 4 shows that the zero intersection point 408 occurs for a point along the audio waveform 402 that crossed the zero portion of the measurement of the y-axis 406. Then, the value of the x-axis 404 for this zero intersection point 408 is recorded for use in the step 312 for correspondingly segmenting the spectrogram that corresponds to this particular audio waveform 402. Remaining portions of the waveform may be used to find other syllable segmentation ending and starting points for other syllables in the word recorded in this audio waveform 402.

For any language in which each word consists of one syllable, then step 312 may be omitted. For these languages, each word spectrogram will inherently provide a spectrogram per syllable.

In step 314 of the converter training preparation process 300 shown in FIG. 3, the divided textual segments are embedded into one-hot encoding embeddings. These divided textual segments are those segments that were produced in step 310. For languages which inherently have one syllable per word so that step 310 was skipped in the converter training preparation process 300, the words themselves represent the divided textual segments for step 314. Embeddings are dense numerical representations of real-world objects and relationships, expressed as a vector. The divided textual segments may as a part of step 314 be input into an autoencoder or predictor in order to generate these one-hot encoding embeddings. The autoencoder or predictor may as an output produce the one-hot encoding embeddings in response to receiving the divided textual segments as input. The divided textual segments are input as a sequence of syllables. The sequence refers back to the original input text—with the various pieces (text syllables) together being arranged in the correct order to create the original word, phrase, sentence, and/or paragraph that was provided as input text. Similar to natural language processing of textual tokens to one-hot encoding embeddings, each divided textual segment is assigned a unique index of a vocabulary group that includes all distinct textual segments of different languages. A textual segment is converted to the corresponding one-hot encoding embedding based on the assigned index. That means that in a one-hot encoding embedding the dimension index is same as the assigned index of a textual segment, the corresponding dimension value is one, and the other dimension values are all zero.

In step 316 of the converter training preparation process 300 shown in FIG. 3, the sequences of text syllable embeddings and the corresponding sequences of syllable spectrograms are recorded as pairs. The text syllable embeddings were generated in step 314. The sequences of syllable spectrograms in these pairs refers to those spectrograms that were generated in step 308 and involved in step 312. This recording may occur in computer memory that is part of the computer and/or server and/or that is accessible to the computer/server syllables. These pair recordings may subsequently be used in training the system for performing the syllable-based text conversion 116 for pronunciation help.

In step 318 of the converter training preparation process 300 shown in FIG. 3, a determination is made as to whether another language is present for adding to the system. If the determination of step 318 is affirmative and another language is present for adding to the system, the converter training preparation process 300 returns to step 302 for a repeat of steps 302, 304, 306, 308, 310, 312, 314, and 316 for the additional language. If the determination of step 318 is negative because no other language is present for adding to the system, the converter training preparation process 300 proceeds to a phase for training the machine learning model. In the drawings, this phase is shown with the training pipeline 500 that is depicted in FIG. 5.

FIG. 5 illustrates a training pipeline 500 for training a syllable-based text conversion program according to at least one embodiment. Specifically, the training pipeline 500 illustrates training of a machine learning model that later functions as part of the program for syllable-based text conversion 116. The machine learning model that is implemented as part of the program for syllable-based text conversion 116 to achieve the pronunciation help that is depicted in FIGS. 2A and 2B may be referred to as a syllable-based text converter 510. For performing training as depicted in FIG. 5, the group 502 is used which includes various training components.

A sequence of textual syllable embeddings 503, the source language 504, and the target language 506 are received as inputs in order to perform the training with the group 502. Because FIG. 5 depicts a training phase, the sequence of textual syllable embeddings 503 and the source language 504 may be determined from the converter training preparation process 300 that was shown in FIG. 3 and described above. The sequence of textual syllable embeddings 503 may be generated from the text corpus that was received in step 302. The language of the text corpus and, therefore, of the text that produced the sequence of textual syllable embeddings 503, is the source language 504. This source language may be automatically identified by a machine learning model which reads the text corpus and/or may be manually input via a trainer who interacts with computer-generated graphical user interfaces associated with the training software. The target language 506 may be updated as the system is trained to convert text into a plurality of other languages starting from a first source language 504. The training pipeline 500 may be repeated multiple times in order to train for conversion from a first starting language into a plurality of other target languages.

The training pipeline 500 includes inputting the sequence 503 of textual syllable embeddings into the encoder 508. The encoder 508 may be a machine learning model. The machine learning model may in at least some embodiments implement Long Short-Term Memory (LSTM). The LSTM is a type of recurrent neural network capable of learning order dependence in sequence prediction. The encoder 508 evaluates the sequence 503 of textual syllable embeddings to understand the order dependence of the textual syllables and their embeddings. Recurrent networks have an internal state that can represent context information. The encoder 508 maintains information about past inputs for an amount of time that is not fixed a priori, but rather depends on its weights and on the input data. The encoder 508 may include a recurrent neural network whose inputs are not fixed but rather constitute an input sequence. In this manner, the encoder 508 may be used to transform an input sequence into an output sequence while taking into account contextual information in a flexible way. The encoder 508 as output may produce a last hidden state, and this last hidden state may be input into the syllable-based text converter 510.

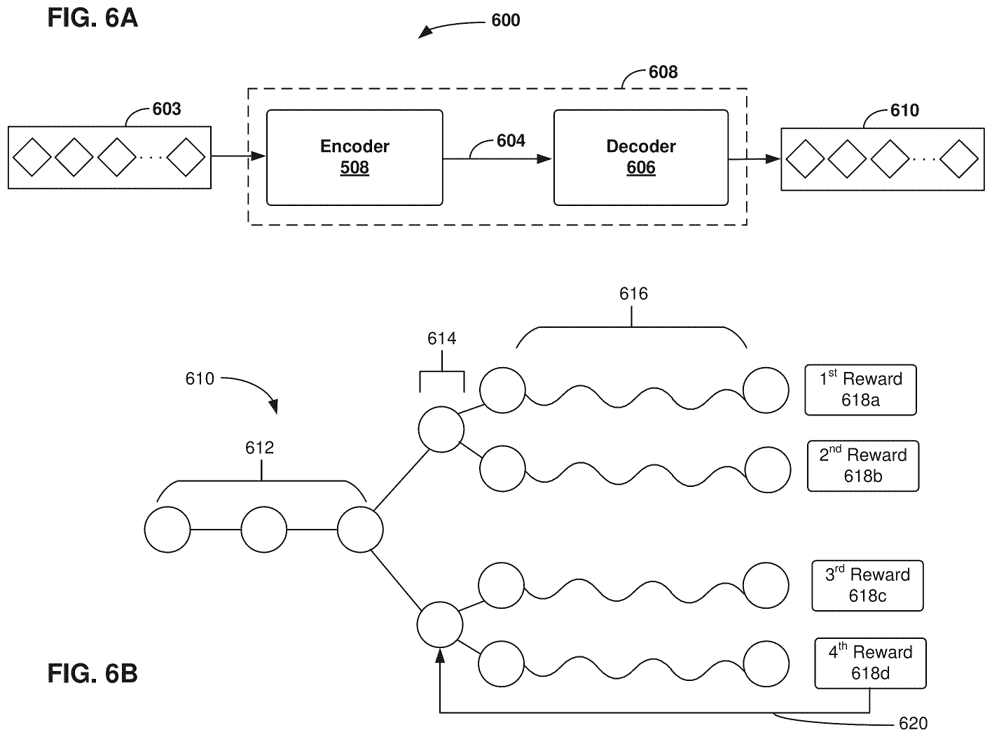

Before being implemented in the training pipeline 500, in at least some embodiments the encoder 508 is trained to better understand the effect of sequential order in input sequences. FIG. 6A shows an encoder training pipeline 600 which may be used to train the encoder 508 to properly prepare the encoder 508 for usage in the training pipeline 500 and also eventually for syllable-based text conversion 116. FIG. 6A shows that an input sequence of textual syllable embeddings 603 is input into the encoder 508. The various textual syllable embeddings 603 may be generated from a text training dataset such as the text corpus received in step 302 of the converter training preparation process 300 shown in FIG. 3. A preprocessing module may produce these embeddings from the words of the text training dataset. For this preprocessing, a unique index of a vocabulary group that includes all distinct textual segments of different languages to be involved for the program is assigned to a syllable from each of the words of the text corpus. A textual segment is converted to the corresponding one-hot encoding embedding based on the assigned index. That is, in a one-hot encoding embedding, the dimension index is same as the assigned index of a textual segment, the corresponding dimension value is one, other dimension values are all zero.

Thus, the encoder training pipeline 600 includes sending multiple input sequences of textual syllable embeddings 603 into the encoder 508. The decoder 606 may be produced by replicating the encoder 508. The encoder 508 and the decoder 606 together may constitute a deep learning model 608.

The deep learning model 608 may be trained via sequence prediction and via auto-regressive language modeling, e.g., left-to-right sequencing. An encoder-decoder architecture, e.g., an autoencoder, in at least some embodiments is an example of the deep learning model 608. The training text corpus may be broken down into numerous segments and input sequences of textual syllable embeddings 603 to receive such auto-regressive language modeling. The last hidden state of the encoder 508 is transmitted in an encoder transmission 604 to the decoder 606 as input to the decoder 606. The training of the deep learning model 608 may include cross entropy loss and backpropagation to update and refine the parameters of the encoder 508. The decoder 606 produces as its output and as output of the deep learning model 608 a predicted sequence 610 of textual syllable embeddings. This predicted sequence 610 is used for the cross entropy loss and backpropagation. Backpropagation is an algorithm for training neural networks and may be used to help fit a neural network. Backpropagation may compute the gradient of the loss function with respect to the weights of the network and may be used to help train multilayer networks including by updating weights to minimize loss. The gradient of the loss function may be determined with respect to each weight by the chain rule. The gradient may be computed one layer at a time—iterating backward from the last layer to avoid redundant calculations of intermediate terms in the chain rule. Cross-entropy may be used as a loss function when optimizing neural networks that are performing classification.

The decoder 606 helps train the encoder 508 for later use. The decoder 606 is not needed for implementation in the training pipeline 500 and is also subsequently no needed for a prediction phase in which the trained syllable-based text converter 510 performs text conversion for pronunciation help.

The training pipeline 500 includes the last hidden state of the encoder 508 being input into the syllable-based text converter 510. The syllable-based text converter 510 also includes a machine learning model. The machine learning model in at least some embodiments implements Long Short-Term Memory (LSTM). The syllable-based text converter 510 also receives as input the target language 506. The target language 506 is input into the syllable-based text converter 510 as a one-hot encoding vector. The one-hot encoding vector of the target language 506 and the last hidden state of the encoder 508 may for the inputting be concatenated together to form an initial hidden state for the syllable-based text converter 510. The syllable-based text converter 510 samples existing textual syllable embeddings and generates a sequence of textual syllable embeddings in the target language 506. The textual syllable embeddings in the target language 506 that are generated by the syllable-based text converter 510 may be one-hot encoding embeddings.

Before being implemented in the training pipeline 500, in at least some embodiments the syllable-based text converter 510 is pre-trained to enhance and/or teach an ability to convert the text syllables. This pre-training may include using maximum likelihood estimation (MLE) which involves defining a likelihood function for calculating the conditional probability of observing a data sample given a probability distribution and distribution parameters. The MLE approach may be used to search a space of possible distributions and parameters. The MLE may be applied for the syllable-based text converter 510 to all sequences of textual syllable embeddings in every language from all text training datasets used for training the program. Cross entropy loss and backpropagation may be used to update parameters of the syllable-based text converter 510. During this pre-training, the syllable-based text converter 510 may not take in the last hidden state from an encoder such as the encoder 508 and instead has an initial hidden state that is initialized to zero values.

Before being implemented in the training pipeline 500, in at least some embodiments the syllable-based text converter 510 is also trained to further enhance and/or teach an ability to convert the text syllables. This training may occur after the pre-training of the syllable-based converter 510 that was described above. This training may include randomly selecting a sequence of textual syllable embeddings in a random source language from the training dataset and fed into the encoder 508 that has been trained. Then, the syllable-based text converter 510 takes in the last hidden state of the encoder 508 and a random target language, and outputs a sequence of textual syllable embeddings in this random target language. A policy gradient such as the policy gradient 620 shown in FIG. 6B may be used to train the syllable-based text converter 510. For this training, the final reward signal may be provided by multiple providers, for example the classifier 514 and the audio-sequence similarity calculation module 520 shown in FIG. 5. The final reward signal may be passed back to the intermediate action value via a Monte Carlo search.

Below is an example of an action-value function of a sequence that may in at least some embodiments be implemented for training the syllable-based text converter 510. For the action-value function below, Q^{G}^{_{θ}} indicates a final reward signal calculated based on a state (that is, “s” which is identical to Y_{1:t-1}) and a next action (that is, “a” which is identical to yₜ).

$${Q}^{{G}_{θ}} ( s = {Y}_{1 : t - 1 ′} a = {y}_{t} ) = \{ \begin{matrix}\frac{1}{N} {\sum }_{n = 1}^{N} ( {λ}_{1} * 𝒞 ( {Y}_{1 : T}^{n} ) + {λ}_{2} * 𝒮 ( {Y}_{1 : T}^{n} , 𝕤 ) ) , {Y}_{1 : T}^{n} ∈ {MC}^{{G}_{β}} ( {Y}_{1 : t} ; N ) & for t < T \\ {λ}_{1} * 𝒞 ( {Y}_{1 : T} ) + {λ}_{2} * 𝒮 ( {Y}_{1 : T} , 𝕤 ) & for t = T\end{matrix}$$

where T is a predetermined maximum sequence length; Y_{1:t} is a sequence of target-language textual syllable embeddings with a size of t which is generated by the syllable-based text converter 510; MC^{G}^{_{β}}(Y_{1:t}; N) indicates performing a Monte Carlo (MC) search to generate a total of N sequences of target-language textual syllable embeddings based on Y_{1:t}; Y_{1:T}ⁿ is an n-th sequence of target-language textual syllable embeddings with a size of T which is generated by a Monte Carlo search; [symbol] (⋅) is an estimated probability of a sequence of target-language textual syllable embeddings being classified as a target language by the classifier 514 as the reward; [symbol] (⋅) is an audio-sequence similarity value between a sequence of target-language textual syllable embeddings and [symbol] that is calculated by the audio-sequence similarity calculation module 520 as the reward; [symbol] is a randomly-selected sequence of textual syllable embeddings in the source language 504; and λ₁ and λ₂ are hyper-parameters that represent the respective weights of [symbol] (⋅) and [symbol] (⋅), whereby λ₁+λ₂=1. In at least some embodiments, the training in the training pipeline 500 uses λ₁=0.4 and λ₂=0.6.

FIG. 6B illustrates a policy gradient pipeline 610 which illustrates how a policy gradient 620 may be implemented for training a syllable-based text converter 510 according to at least one embodiment. In the policy gradient pipeline 610, the state 612 leads to a next action 614. The next action 614 leads to a Monte Carlo search 616. The Monte Carlo search 616 results in generating a total of N sequences of target-language textual syllable embeddings based on a state 612 and a next action 614. In the example embodiment depicted in FIG. 6B, N is set to four. In the training pipeline 500, for each generated sequence two reward providers generate respective rewards. In the example training pipeline 500 shown in FIG. 5, the two reward providers are classifier 514 and the audio-sequence similarity calculation module 520. For example, a first reward 618a is generated for a first generated sequence of target-language textual syllable embeddings, a second reward 618b is generated for a second generated sequence of target-language textual syllable embeddings . . . and so on until an N-th reward is generated. Because FIG. 6B shows the example of N being set to four, a first reward 618a, a second reward 618b, a third reward 618c, and a fourth reward 618d are shown as being created. The policy gradient 620 is the average of N rewards and leads back to the next action 614 which illustrates the nature of training and refining the syllable-based text converter 510.

When the syllable-based text converter 510 is trained, the maximum length of a generated sequence by the syllable-based text converter 510 is equal to the length of the input sequence of textual syllable embeddings. If there are textual syllable embeddings in a non-target language and/or if there are audio syllable embeddings, then such embeddings are removed from both the input and generated sequences which have the same sequence indices. If all embeddings are removed from the generated sequence, then the current generated sequence may be excluded from N times of the Monte Carlo search. If the length of a generated sequence by the syllable-based text converter 510 is less than the length of the input sequence of textual syllable embeddings, all those generated embeddings may be used to calculate cosine similarity. Even with this approach, the sum is still divided by the length of the input sequence of audio syllable embeddings in the source language.

When prediction is subsequently performed with the syllable-based text converter 510, the syllable-based text converter 510 may generate M different outputs and choose the generated sequence which sounds most like the source text.

The training pipeline 500 shows that the output of the syllable-based text converter 510 is a generated sequence 512 of target-language textual syllable embeddings. Thus, the output of the syllable-based text converter 510 shows the transformation performed with at least some of the present embodiments—namely that the source-language textual syllable embeddings become target-language textual syllable embeddings.

The training pipeline 500 shows that the generated sequence 512 of target-language textual syllable embeddings is input into a classifier 514. The classifier 514 may also be/include a machine learning model. The classifier 514 may implement Long Short-Term Memory (LSTM) and classifies the language category of the generated sequence 512 of target-language textual syllable embeddings. The classifier 514 may include an output layer that assigns decimal probabilities to each class in a multi-class problem, e.g., a SoftMax output layer. The classes may include each language for which the syllable-based text conversion 116 will be capable of providing pronunciation help. Therefore, if the syllable-based text conversion 116 is trained for pronunciation conversion help between two hundred different languages, then the classifier output layer produces a vector which indicates which of the two hundred different languages is the target language. The total number of dimensions of the one-hot encoding vector may be the total number of different languages for which the system is trained plus one. The plus one addition is caused by a special language category called “Mixed language”. This vector indicating the target language constitutes the language category that is predicted via the classifier 514.

In one example, the classifier 514 may generate a vector such as (1, 0, 0, . . . , 0). The dimension with a one instead of a zero indicates which language is predicted. In some instances, a one in the first position may refer to the “Mixed language” category”. The one in the second position. e.g., (0, 1, 0, . . . , 0), may refer to another language such as English. The one in the third position, e.g., (0, 0, 1, . . . , 0), may refer to another language such as Chinese. The dimension index which has the maximum value in such output vector indicates the corresponding language (category). For example, in some embodiments the output vector from the classifier may appear as (0.001, 0.98, 0.001, . . . , 0) which may be interpreted as a one for the second position. Because the second dimension has the maximum value (0.98) in this example, the identified language category is English.

The classifier 514 does not receive the target language 506 directly as an input. Rather, the classifier 514 receives embeddings—namely the generated sequence 512 of target-language textual syllable embeddings. The classifier 514 then determines the target language based on the generated sequence 512 of target-language textual syllable embeddings.

Before being implemented in the training pipeline 500, in at least some embodiments the classifier 514 is trained to teach language category prediction. For this training, a sequence of textual syllable embeddings in a certain language may be randomly selected from the textual training dataset. For this sequence, a corresponding training label is the language of the selected sequence. In the meantime, a few textual syllable embeddings in other languages or audio syllable embeddings are randomly inserted into a randomly-selected sequence of textual syllable embeddings in one language as an input. The corresponding training label is a special language category called ‘Mixed language’. Cross entropy loss and backpropagation may be implemented in this training to update the parameters of the classifier 514.

The training pipeline 500 shows that multiple inputs are input from different sources into a syllable-based text-to-audio generator 518. These multiple inputs include as a first input 531 the sequence 503 of source-language textual syllable embeddings, as a second input 532 the generated sequence 512 of target-language textual syllable embeddings, as a third input 533 the source language 504, and as a fourth input 534 the target language 506. This reference to first, second, third, and fourth inputs does not refer to a sequence but instead is used for clarity and organization in this document.

The syllable-based text-to-audio generator 518 uses the first input 531 and the third input 533 to produce a corresponding sequence of audio syllable embeddings in the source language. These audio syllable embeddings may be one-hot encoding embeddings. The syllable-based text-to-audio generator 518 uses the second input 532 and the fourth input 534 to produce a corresponding sequence of audio syllable embeddings in the target language. These audio syllable embeddings for both source and target languages may be one-hot encoding embeddings.

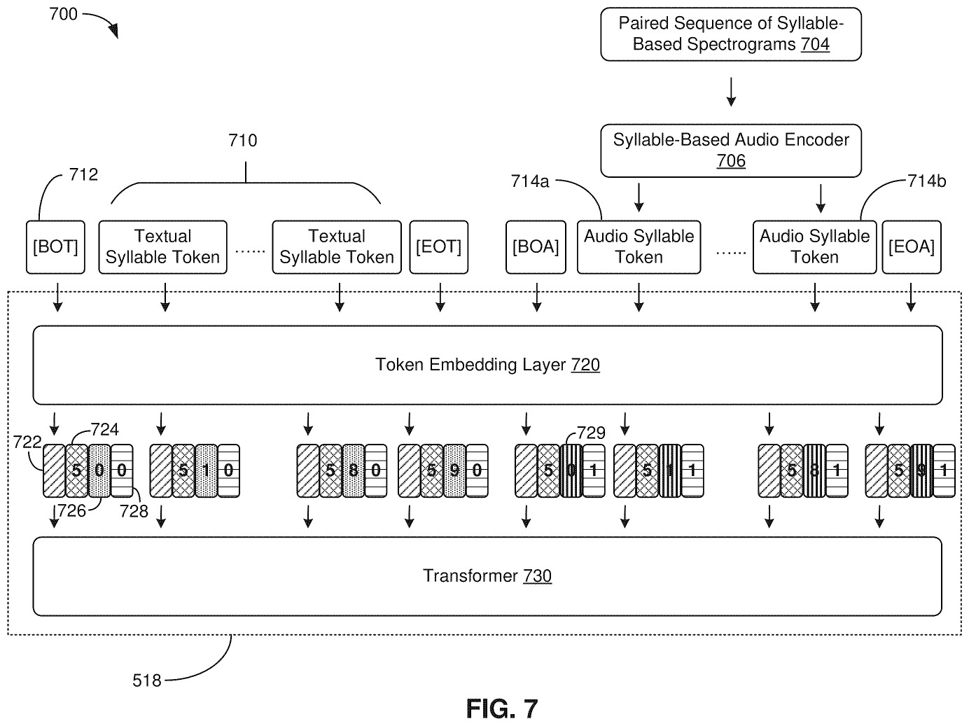

Before being implemented in the training pipeline 500, in at least some embodiments the syllable-based text-to-audio generator 518 is trained to receive text-to-audio generation capabilities. FIG. 7 shows a text-to-audio generator training pipeline 700 which depicts training aspects for training the syllable-based text-to-audio generator 518. As shown in FIG. 7, the syllable-based text-to-audio generator 518 may in at least some embodiments include two main components—namely the token embedding layer 720 and the transformer 730. The transformer 730 may in at least some embodiments be a decoder-only transformer.

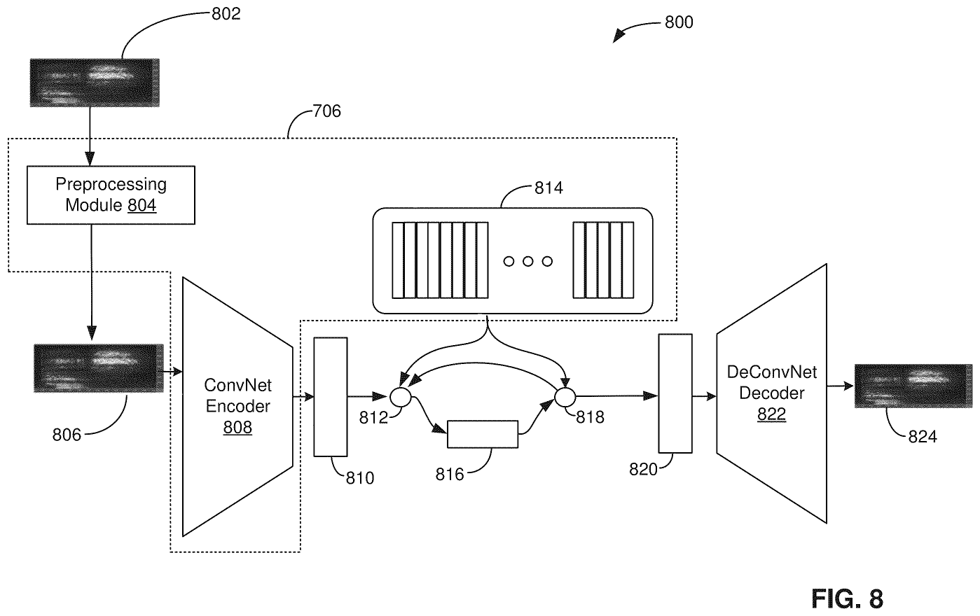

As depicted in the text-to-audio generator training pipeline 700 in FIG. 7, the syllable-based text-to-audio generator 518 may be trained by receiving textual syllable tokens and by receiving audio syllable tokens for the syllables which correspond to the textual syllables. These textual syllables tokens correspond to those embeddings that were formed in step 314 in the converter training preparation process 300 shown in FIG. 3. These textual syllable tokens formed in step 314 were created from the textual syllables that were segmented in step 310 and came from the text corpus that was received in step 302. The audio syllable tokens are generated via the syllable-based audio encoder 706 whose training is described in more detail in FIG. 8 of the drawings. The sequence of syllable-based spectrograms 704 which were generated in step 312 of the converter training preparation process 300 shown in FIG. 3 are input into the syllable-based audio encoder 706. In response to receiving this input, the syllable-based audio encoder 706 produces as output the audio syllable tokens. A first audio syllable token 714a and a second audio syllable token 714b are labelled in FIG. 7.

FIG. 8 shows the inter components of the syllable-based audio encoder 706 and shows an audio encoder training pipeline 800. The audio encoder training pipeline 800 is used to train the syllable-based audio encoder 706 so that the syllable-based audio encoder 706 is ready to be implemented in the text-to-audio generator training pipeline 700 shown in FIG. 7. FIG. 8 shows the inter components of the syllable-based audio encoder 706 as including the preprocessing module 804, the ConvNet encoder 808, and the codebook 814. Once the ConvNet encoder 808 and the codebook 814 are trained via performing of the audio encoder training pipeline 800 shown in FIG. 8, then the preprocessing module 804, the ConvNet encoder 808, and the codebook 814 are ready to be implemented as the syllable-based audio encoder 706 in the text-to-audio generator training pipeline 700 shown in FIG. 7.

In at least some embodiments, the ConvNet encoder 808, the DeConvNet decoder 822, and the codebook 814 are trained as shown in the audio encoder training pipeline 800. This training occurs via a variational autoencoder that uses vector quantization to obtain a discrete latent representation. The ConvNet encoder 808 is trained to output discrete, rather than continuous, codes. The prior is learnt rather than static. Therefore, this training is comparable to VQ-VAE training. The training is performed with all of the syllable-based spectrograms from the training dataset, namely for those syllable-based spectrograms that were produced in step 312 of the converter training preparation process 300 that was depicted in FIG. 3 and described above. A ConvNet encoder and the DeConvNet decoder refer to a convolutional-based encoder and a deconvolutional-based decoder, respectively, that are part of an encoder-decoder network.

In the audio encoder training pipeline 800, for a syllable-based spectrogram 802 with the size of 257×T×3 (whereby T indicates the seconds to pronounce a certain syllable multiplied by 10) the syllable-based spectrogram 802 is preprocessed via the preprocessing module 804 to fit into the size of 256×256×3 at first. This preprocessing results in a preprocessed spectrogram 806 being output from the preprocessing module 804. Then, the preprocessed spectrogram 806 is input into the ConvNet encoder 808 and is encoded via the ConvNet encoder 808 to produce a vector 810 which may in some embodiments be a 1024-dimensional vector. After vector 810 is produced, then stage 812 is performed. In stages 812 and 818, nearest-neighbor mapping is performed by accessing other vectors in the codebook 814 to find a codebook vector 820 from the codebook 814 that is most similar to the vector 810. After the codebook vector 820 is identified, an index value (ranging from N to N+K) of the identified codebook vector 820 in the codebook 814 is obtained. The index value from the codebook 814 may be converted to be a one-hot encoding embedding as the output audio syllable token 816. When subsequently implemented in the text-to-audio generator training pipeline 700 shown in FIG. 7, this output audio syllable token 816 is used as one of the audio syllable tokens such as the first audio syllable token 714a or the second audio syllable token 714b.

K is a hyper-parameter and is equal to the total number of unduplicated audio syllables. N is also a hyper-parameter and is equal to the total number of all textual syllable embeddings (including several special embeddings, such as [BOT]). Pronouncing a syllable takes a time which may be measured in seconds. The length of time depends on the particular syllable that is being pronounced. Suppose a syllable needs (0.1×X) seconds. Then, the size of the spectrogram for this syllable is 257×(X multiplied by 10)×3.2.5 seconds (that is, 0.1×X, where X=25) may be taken as the maximum possible time (T) for pronouncing a single syllable. A single-syllable spectrogram with a smaller width may be placed in the center of an imaginary spectrogram with a size of 256×256×3, and the blanks on both sides are filled in with black color. Audio-syllable tokens are later fed into the transformer 730 shown in FIG. 7 and multiplied with the embedding matrix of the transformer 730 to obtain the related vector from within the embedding matrix. To look up in the codebook 814 that is trained, the last K dimensions of an audio-syllable token are truncated and then multiplied with the codebook 814 to obtain the related codebook vector 820.

In one example, the index is exactly N. Then the corresponding audio-syllable token has a dimension value 1 at its N-th dimension. The other dimensions are all zero. The stage 818 represents fetching from the codebook 814 a codebook vector 820 that corresponds to the audio syllable token 816. In one example, if the N-th dimension of the audio syllable token 816 has a value of “1” and the values of the other dimensions of this audio syllable token 816 are all “0”, then this audio syllable token 816 corresponds to the index “N” in the codebook 814. This index is for the first embedding stored in the codebook 814, because the index of the codebook 814 ranges from N to N+K and does not start at the value 0. Thus, the first embedding is fetched from the storage of the codebook 814 as the codebook vector 820 and is fed to the DeConvNet decoder 822 to produce the reconstructed spectrogram 824.

During forward computation, the codebook vector 820 is passed to the DeConvNet decoder 822. During a backwards pass in the training, a gradient ∇_{Z}L is passed unchanged from stage 818 to 812 and reaches the ConvNet encoder 808. Because the output representation of the ConvNet encoder 808 and the input to the DeConvNet decoder 822 share the same multi-dimensional space the gradients contain useful information for how the ConvNet encoder 808 must change its output to lower the reconstruction loss.

Therefore, in at least some embodiments a syllable-based audio encoder 706 is implemented which is enhanced compared to a standard VQ-VAE model. The syllable-based audio encoder 706 is used to encode a single-syllable spectrogram to an audio-syllable token with the size of 1×1×(N+K), instead of a feature map with the size of 32×32×256. The ConvNet encoder 808 may be an eight-layer convolutional neural network with 1024 hidden units and ReLU activation for each layer. Each layer may have a receptive field of four and a stride of two to halve the width and height of images. The DeConvNet decoder 822 may have the same architecture that the ConvNet encoder 808 has except the DeConvNet decoder 822 performs deconvolution instead of convolution. The range of the indices of vectors in the trainable codebook 814 is changed to [N, N+K].

Referring again to the text-to-audio generator training pipeline 700 shown in FIG. 7 which depicts training aspects for training the syllable-based text-to-audio generator 518, As shown in FIG. 7, the syllable-based text-to-audio generator 518 may in at least some embodiments include two main components—namely the token embedding layer 720 and the transformer 730. The transformer 730 may in at least some embodiments be a decoder-only transformer. When trained, the syllable-based text-to-audio generator 518 may generate a sequence of audio-syllable (one-hot encoding) embeddings based on an input sequence of textual-syllable tokens and the related language category.

This transformer 730 in at least some embodiments is unidirectional and includes many layers and attention heads. The training in the text-to-audio generator training pipeline 700 shown in FIG. 7 may include autoregressive language modeling such as left-to-right token prediction. A random sequence of textual-syllable tokens 710 (represented as one-hot encoding embeddings) and the corresponding (paired) sequence of syllable-based spectrograms 704 are selected from the training dataset. Each included syllable-based spectrogram of the paired sequence of syllable-based spectrograms 704 will be converted to a corresponding audio-syllable token (represented as a one-hot encoding embedding) by using the syllable-based audio encoder 706 at first. FIG. 7 shows an example that multiple audio syllable-based tokens including a first audio syllable token 714a and a second audio syllable token 714b are generated for a particular input sequence. Both the textual and audio syllable tokens are equally treated, because the textual-syllable tokens 710 of all languages and audio-syllable tokens share the same (one-hot encoding) embedding space. This embedding space may include textual-syllable tokens ranging from 0 to N−1 and audio-syllable tokens ranging from N to N+K.

As depicted in FIG. 7, in at least some embodiments four separator tokens are added to the textual/audio syllable tokens that are paired with each other. A first separator token 712 is labelled in FIG. 7. These four separator tokens may include the first separator token 712 as a [BOT] (beginning of textual-syllable-token sequence), may include an [EOT] (end of textual-syllable-token sequence), may include a [BOA] (beginning of audio-syllable-token sequence) and may include an [EOA] (end of audio-syllable-token sequence). Such a group of separator tokens may be added to each sequence as the boundaries. These tokens are input along with the other tokens into the token embedding layer 720.

In response to receiving the token group as input, the token embedding layer 720 generates embeddings for each of the tokens of the input token group. These generated embeddings include token embeddings 722, modal-type embeddings 728, position embeddings 726, 729, and language-category embeddings 724. The final input embeddings taken by the transformer 730 are the sum of the token embeddings 722, modal-type embeddings 728, position embeddings 726, 729, and language-category embeddings 724. All of the input sequences may be clipped or padded to a length of 1024. The position embeddings 726 are for those produced from the textual syllable tokens. The position embeddings 729 are for those produced from the audio syllable tokens. FIG. 7 shows the modal-type embeddings 728, position embeddings 726, 729, and language-category embeddings 724 as including particular values representing the embeddings.

The training pipeline 500 shows that multiple outputs from the syllable-based text-to-audio generator 518 are input into an audio-sequence similarity calculation module 520. The audio-sequence similarity calculation module 520 compares the sequence of audio syllable embeddings in the source language that was produced via the syllable-based text-to-audio generator 518 with the sequence of audio syllable embeddings in the target language that was also produced in the syllable-based text-to-audio generator 518. FIG. 5 shows that the sequence of audio syllable embeddings in the source language may be passed to the audio-sequence similarity calculation module 520 in a first transmission 535. FIG. 5 also shows that the sequence of audio syllable embeddings in the target language may be passed to the audio-sequence similarity calculation module 520 in a second transmission 536.

In at least some embodiments, the audio-sequence similarity calculation module 520 comparing the sequence of audio syllable embeddings in the source language to the sequence of audio syllable embeddings in the target language produces and/or calculates an audio-sequence similarity value, e.g., a cosine similarity value. The comparison may include replacing each audio-syllable embedding in the two input sequences with a vector from within a trained codebook 814 based on the mapping between the one-hot encoding embedding of the respective input sequence and the indices of the trained codebook 814. The cosine similarity between each pair of two codebook vectors with the same index from the two sequences may be calculated starting from the beginning of the two replaced sequences. The final audio-sequence similarity value may be equal to the sum of all cosine similarities divided by the length of the input sequence of audio syllable embeddings in source language.

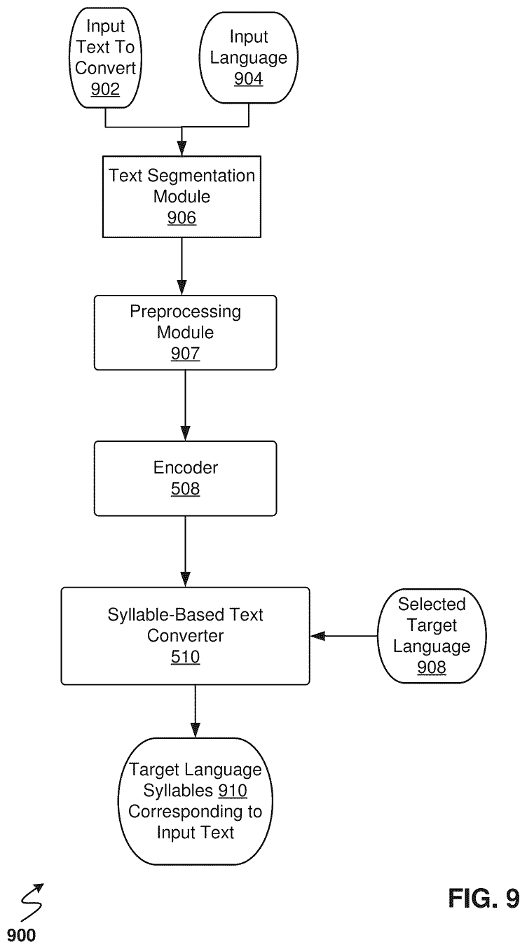

FIG. 9 illustrates a prediction phase pipeline 900 in which the syllable-based text converter 510 now having been trained via the training pipeline 500 depicted in FIG. 5 is used to provide pronunciation help in real time for a user such as occurs for the user 202 in the pronunciation help environment 200 shown in FIGS. 2A and 2B. Thus, the prediction phase pipeline 900 of FIG. 9 shows internal aspects of the program for text-syllable conversion 116 being operated at the client computer 101, e.g., at the laptop computer of the user 202 shown in FIGS. 2A and 2B. The user 202 engages the program to ask for pronunciation help regarding a particular phrase, word, sentence, and/or other text portion. These word(s) are input into the program as input text to convert 902 in the prediction phase pipeline 900. The input language 904 is also input into the program. This input language 904 may be designated/selected by the user 202 via engagement with the program or the program may perform text recognition to identify the input language 904.

Because this input language 904 is part of the prediction phase instead of a training phase, the input language 904 depends on the language of the input text that was input by the user in the present prediction session and not on the source language 504 that was input for the training pipeline 500 depicted in FIG. 5. Depending on the choice of the user who is requesting pronunciation help by actuating the program or on the recognition of the program recognizing a language that appears on the computer screen, the input language 904 may be the same as or different from the source language 504 that was used in one particular round of training the syllable-based text converter 510 in the training pipeline 500 shown in FIG. 5.

The input text to convert 902 and the input language 904 are input into the text segmentation module 906 which is part of the program for text-syllable conversion 116. The text segmentation module 906 divides the input text into textual segments. The text segmentation module 906 may include a copy of a special word-mapping table that was described above with respect to the converter training preparation process 300 shown in FIG. 3.

The input text may be scanned through the mapping table to check for any hits of stored special words before proceeding to the main portion of the text segmentation module 906. If the input text is identified in the special word mapping table, then the segmentation may be retrieved from the table so that the main portion of the text segmentation module 906 which performs rule-based segmentation and/or stored syllable segmentation for known words may be skipped.

In instances when the input text includes a word which has multiple entries in the mapping table, in at least some embodiments one of the multiple entries may be selected based on contextual words. Specifically words such as nouns and/or verbs from text in the vicinity of the input text may be compared with contextual words in the mapping table. Those contextual words in the mapping table were saved associated with this special word. Such contextual words may help determine which of different pronunciations should be implemented for a particular special word spelling. For example, the context may indicate that the special word(s) refers to a geographical location with a first pronunciation instead of to a famous person with the same name spelling but a second different pronunciation.

These textual segments are then fed to a preprocessing module 907 which converts the syllable segments from the segmentation module 906 into one-hot encoded embeddings. Similar to natural language processing of text words to tokens, the syllable segments are converted in this preprocessing module 907 to a one-hot encoded embedding according to its assigned token index, e.g., ranging from 0 to N−1. For example, when the index for the segmented syllable “ven” is 0, then the one-hot encoded embedding for “ven” is (1, 0, 0, . . . , 0) meaning that the first dimension value is 1 but the other dimension values are 0. The one-hot encoded embeddings are thereafter input into the encoder 508. This encoder 508 is implemented here having already been trained in the training pipeline 500 depicted in FIG. 5. The encoder 508 provides the last hidden state to the syllable-based text converter 510. The syllable-based text converter 510 also receives as input the selected target language 908. The user may in some engagement with the program select a target language to create the selected target language 908 as input for the syllable-based text converter 510.

Because this selected target language 908 is part of the prediction phase instead of a training phase, the selected target language 908 depends on the choice selected by the user in the present prediction session and not on the target language 506 that was input for the training pipeline 500 depicted in FIG. 5. Depending on the choice of the user who is requesting pronunciation help by actuating the program, the selected target language 908 may be the same as or different from the target language 506 that was used in one round of training the syllable-based text converter 510 in the training pipeline 500 shown in FIG. 5.

Now having been trained and using the output of the encoder 508 and the selected target language 908, the syllable-based text converter 510 generates, as output, target language syllables 910 that correspond to the input text. These target language syllables 910 may be presented to the user in a variety of ways in order to help this user pronounce the input text in a way more readily understood by the user. FIG. 2B shows the pronunciation help converted text 212 which is an equivalent to the target language syllables 910 as output that is shown in FIG. 9 as part of the prediction phase pipeline 900.

Because the syllable-based text converter 510 has been trained, during the prediction phase pipeline 900 a new audio waveform and a new spectrogram do not need to be generated each time. Nevertheless, the inner workings of the syllable-based text converter 510 are still based on a comparison of spectrograms because the training of the syllable-based text converter 510 depended on the waveform generation, spectrogram generation, etc. that were performed to the words of the text corpuses of various languages in the training pipeline 500 and/or in the training of the elements used in the training pipeline 500 as depicted in FIGS. 3-4, 6A, 6B, 7, and 8. These words of the text corpuses were received during the converter training preparation process 300 as depicted in FIG. 3. Therefore, the prediction performed with the trained syllable-based text converter 510 as depicted in FIGS. 2A, 2B, and 9 is based on all of the principles and features described with respect to the embodiments depicted in FIGS. 4-9 and previously described in this disclosure.

The computer program for syllable-based text conversion 116 may in some embodiments produce a spectrogram on the fly and use the spectrogram for comparison to other saved spectrograms in order to find syllables that have a pronunciation that most closely matches a pronunciation of input text in the first language for which pronunciation help was requested. Thus, different languages may be evaluated and interpreted even on the fly to provide translation and pronunciation help.

In some embodiments, the program for syllable-based text conversion 116 may ask for feedback from the user after pronunciation help has been given. This feedback may then be applied in one or more of the machine learning models involved in the program for syllable-based text conversion 116 in order to improve the machine learning and the future pronunciation help.

Although the figures and embodiments show that pronunciation help is generated and presented in a single target language, in some embodiments the person user may find the presentation of pronunciation help in multiple languages to be helpful. For example, the user may be familiar with multiple languages or may be attempting to learn a third language. Thus, in these other embodiments, the converting may be performed multiple times to present multiple pronunciation helps, e.g., pronunciation helping characters not only in the Chinese language but also in Spanish and/or Hindi, etc. The user may select multiple programs in a graphical user interface of the program to request this advanced help of determining and presenting the pronunciation help in multiple target languages. The process may be repeated for each language in order to generate this text conversion to the multiple languages. In a default setting of the program, the program will generate pronunciation help in a single target language in order to reduce the computing requirements of the program.

It may be appreciated that FIGS. 2-9 provide only illustration of certain embodiments and do not imply any limitations with regard to how different embodiments may be implemented. Many modifications to the depicted embodiment(s), e.g., to the particular machine learning models that are depicted, may be made based on design and implementation requirements.

For example, preferred machine learning models were described for implementation for the syllable-based text conversion for pronunciation help and for training the text conversion system. In other embodiments, other machine learning models may be implemented for one or more of the training and/or prediction steps described above in the various embodiments. Such alternative machine learning models may include naive Bayes models, random decision tree models, linear statistical query models, logistic regression n models, neural network models, e.g. convolutional neural networks, multi-layer perceptrons, residual networks, long short-term memory architectures, algorithms, deep learning models, deep learning generative models, and other models. Training data should include targets or target attributes which include a correct answer. The learning algorithm finds patterns in input data in order to map the input data attributes to the target. The machine learning models contain these patterns so that the answer can be predicted for similar future inputs. A machine learning model may be used to obtain predictions on new input text. The machine learning model uses the patterns that are identified to determine what the appropriate text conversion for pronunciation help is. Training may include supervised and/or unsupervised learning.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A method for syllable-based pronunciation assistance, the method comprising:
receiving, via a computer, an input text in a first language;
receiving, via the computer, a selection of a target language that is different from the first language;
obtaining, via the computer and from the target language, syllables with a pronunciation most closely matching a pronunciation of the input text in the first language, wherein the obtaining is based on a comparison of one or more spectrograms for the input text with one or more spectrograms for text of the target language; and
presenting, via the computer, the obtained syllables in the target language.

2. The method of claim 1, further comprising:
separating, via the computer, the input text into syllables in the first language, wherein the syllables in the first language are used to generate the one or more spectrograms for the input text.

3. The method of claim 2, further comprising:
calculating, via the computer, a time to pronounce each of the syllables in the first language; and
dividing, via the computer, an input text spectrogram for the input text into a spectrogram per syllable of the input text, wherein the dividing is based on the calculated time.

4. The method of claim 2, further comprising:
identifying, via the computer, points of zero amplitude in an audio waveform generated via pronouncing the input text; and
dividing, via the computer, an input text spectrogram for the input text into a spectrogram per syllable of the input text, wherein the dividing is based on the identified points of zero amplitude.

5. The method of claim 4, further comprising determining a respective time value at the identified points of zero amplitude, wherein the dividing is based on the determined respective time value.

6. The method of claim 2, further comprising:
calculating, via the computer, a time to pronounce each of the syllables in the first language;
identifying, via the computer, points of zero amplitude in an audio waveform generated via pronouncing the input text; and
dividing, via the computer, an input text spectrogram for the input text into a spectrogram per syllable of the input text, wherein the dividing is based on the calculated time and on the identified points of zero amplitude.

7. The method of claim 1, further comprising:
recording as an audio waveform the pronunciation of the input text in the first language; and
generating the one or more spectrograms for the input text based on the audio waveform.

8. The method of claim 1, further comprising generating embeddings from the spectrograms from the received input text, wherein the comparison of the one or more spectrograms for the input text with the one or more spectrograms for the text of the target language comprises comparing the generated embeddings for the input text with embeddings generated from the one or more spectrograms for the text of the target language.

9. The method of claim 8, wherein the comparison of the generated embeddings for the input text with the embeddings generated from the one or more spectrograms for the text of the target language comprises performing cosine similarity calculations.

10. The method of claim 1, wherein the presenting of the obtained syllables in the target language comprises displaying the obtained syllables in the target language on a screen of the computer along with other text in the first language.

11. The method of claim 1, wherein the presenting of the obtained syllables comprises playing an audio recording of the syllables in the target language.

12. The method of claim 1, further comprising receiving, via the computer, an indication of the first language via a selection of the first language.

13. The method of claim 1, further comprising determining, via the computer, the first language via machine learning analysis of text being displayed on the computer.

14. The method of claim 1, wherein the input text is received via a selection of a portion of text that is displayed on a screen of the computer.

15. The method of claim 14, wherein the selection of the portion of the text is made via click-and-drag of a text box over the input text on the screen.

16. The method of claim 1, wherein the obtaining is performed via a first machine learning model that is trained via a second machine learning model, wherein for the training the second machine learning model analyzes embeddings representing the one or more spectrograms for the input text and the one or more spectrograms for the text of the target language.

17. The method of claim 1, wherein the obtaining is performed via a first machine learning model that is trained via an autoencoder, wherein for the training the autoencoder converts the one or more spectrograms for the input text and the one or more spectrograms for text of the target language into respective tokens.

18. The method of claim 1, wherein the obtaining is performed via a first machine learning model that is trained via a second machine learning model, wherein for the training the second machine learning model analyzes a combination of tokens representing textual syllables from the input text and tokens representing the one or more spectrograms for the input text.

19. A computer system for syllable-based pronunciation assistance, the computer system comprising:
one or more processors, one or more computer-readable memories, and program instructions stored on at least one of the one or more computer-readable memories for execution by at least one of the one or more processors to cause the computer system to:
receive an input text in a first language;
receive a selection of a target language that is different from the first language;
obtain, from the target language, syllables with a pronunciation most closely matching a pronunciation of the input text in the first language, wherein the obtaining is based on a comparison of one or more spectrograms for the input text with one or more spectrograms for text of the target language; and
present the obtained syllables in the target language.

20. A computer program product for syllable-based pronunciation assistance, the computer program product comprising a computer-readable storage medium having program instructions embodied therewith, the program instructions executable by a computer to cause the computer to:
receive an input text in a first language;
receive a selection of a target language that is different from the first language;
obtain, from the target language, syllables with a pronunciation most closely matching a pronunciation of the input text in the first language, wherein the obtaining is based on a comparison of one or more spectrograms for the input text with one or more spectrograms for text of the target language; and
present the obtained syllables in the target language.
